(19) United States
(12) Patent Application Publication
(10) Pub. No.: US 2015/0147043 A1
(43) Pub. Date: May 28, 2015

(54) BELT BUCKLE WITH DIGITAL DISPLAY

(71) Applicant: Brandon Lamar Johnson, Raeford, NC (US)

(72) Inventor: Brandon Lamar Johnson, Raeford, NC (US)

(21) Appl. No.: 14/089,082

(22) Filed: Nov. 25, 2013

(51) Int. Cl. A44B 11/00; G11B 33/06; H04N 5/775

(52) U.S. Cl. CPC A44B 11/001; H04N 5/775; G11B 33/06
USPC 386/230

(57) ABSTRACT

A belt buckle with a digital display. A battery may be connected to the digital display so that the belt buckle may be used while wearing the belt buckle on a belt. A memory may be connected the display as well. The memory may store a plurality of still images or videos to be displayed on the digital display. When desired, a user may change the output of the digital display and select either a new image or video stored on the memory.

### BACKGROUND OF THE INVENTION

The present invention relates to a belt buckle and, more particularly, to a belt buckle with a digital display.

A belt buckle is a buckle or clasp for fastening two ends, such as of straps or a belt, in which a device attached to one of the ends is fitted or coupled to the other. Currently, belt buckles are limited to what they look like. Therefore, users must change their belt buckle to achieve a different style.

As can be seen, there is a need for an improved belt buckle.

### SUMMARY OF THE INVENTION

In one aspect of the present invention, an apparatus comprises: a belt buckle comprising a digital display; a battery operatively attached to the digital display; a memory operatively attached to the digital display; and an input, wherein the input facilitates the transfer of data of at least one of a still image and a video to the memory, wherein the digital display of the belt buckle displays the at least one of the still image and video.

In another aspect of the present invention, a method of displaying an image from a belt buckle comprises: providing the belt buckle comprising a digital display, a battery, a memory, and an input, wherein the belt buckle is attached to a belt; placing the belt around a waist of a user and securing the belt to the waist using the belt buckle; uploading data of at least one of a still image and a video to the memory through the input; and displaying the at least one of the still image and the video on the digital display.

These and other features, aspects and advantages of the present invention will become better understood with reference to the following drawings, description and claims.

### BRIEF DESCRIPTION OF THE DRAWINGS

FIG. 1 is a perspective view of the present invention in use; and

FIG. 2 is a perspective view of the buckle of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a belt buckle with a digital display. A battery may be connected to the digital display so that the belt buckle may be used while wearing the belt buckle on a belt. A memory may be connected the display as well. The memory may store a plurality of still images or videos to be displayed on the digital display. When desired, a user may change the output of the digital display and select either a new image or video stored on the memory.

The present invention may include a belt buckle that may be a display for displaying pictures and videos. The belt buckle may in certain embodiments, display high definition picture. The present invention may be used to display one's own personal expression. The present invention may give the user the option of displaying their family members, friends, favorite sports, hobbies, or audiovisual bits in a video mode.

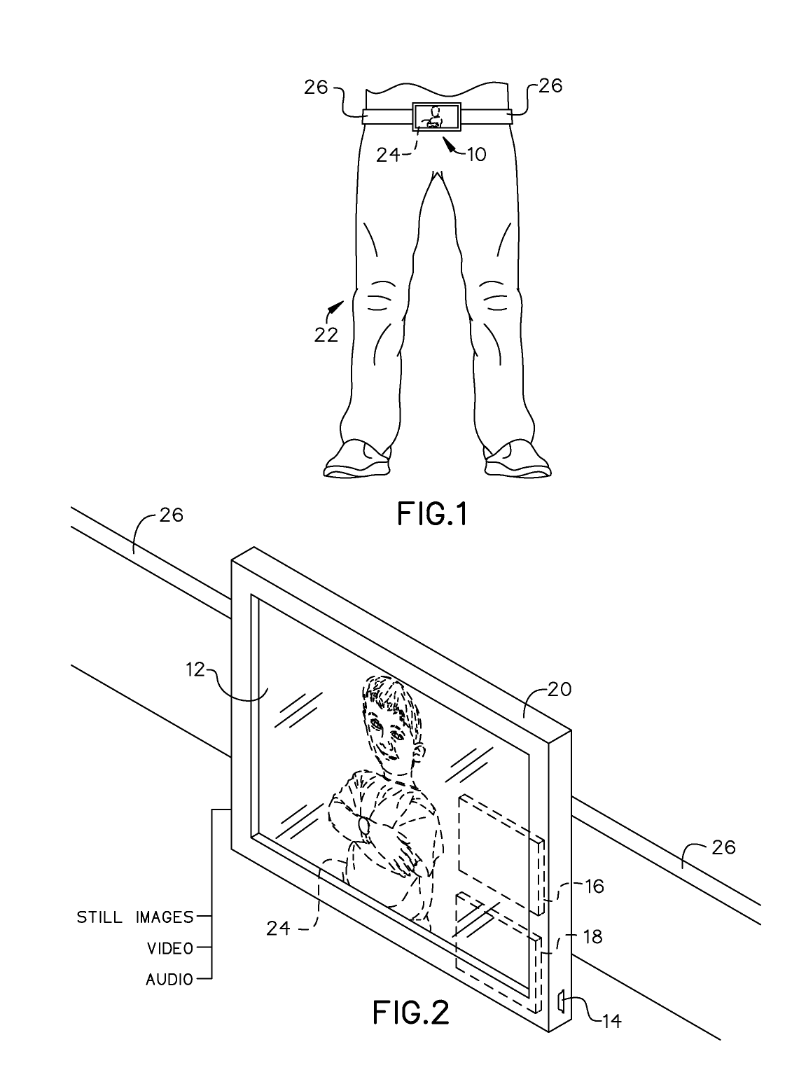

Referring to FIGS. 1 and 2, the present invention may include a belt buckle 10. The belt buckle 10 includes a digital display 12. The digital display 12 may include any digital display, such as but not limited to, a liquid-crystal display (LCD), a plasma display, a light emitting diode display (LED), and the like. The digital display 12 may display still images, and video. The digital display 12 may be contained within a casing 20. The belt buckle 10 may further include speakers for audio. For example, the audio may be in conjunction with a video displayed, or the speaker may play different business mottos or personal mottos.

In certain embodiments, a battery 16 may be used to power the digital display 12. Therefore, the digital display 12 may be wireless. A memory 18 may be operatively connected to the digital display 12 so that data may be stored. The data may include still images, or video to be displayed on the digital display 12. The memory 18 may be about 1 to about 3 gigabytes of memory. The present invention may further include an input 14. The input 14 may be a universal serial bus (USB) so that a user may transfer data from a computer to the digital display 12 to be displayed on the belt buckle 10.

As illustrated, a user 22 may wear the belt 26 with the digital display 12 as the belt buckle 10. The digital display 12 may be displaying an image 24, such as a still image, video or the like. A user 22 may upload data to the memory 18 using the input 14. The data may include a plurality of still images. The user may then place the belt 26 around the users 22 waste to be worn. Then the use may display any visual display from the belt buckle 10 allowing the user to further express themselves. In certain embodiments, the user 22 may pick from the still images, and then select a different still image when the user 22 desires to change the output of the display 12. Further, the user 22 may display a logo or other promotional display.

It should be understood, of course, that the foregoing relates to exemplary embodiments of the invention and that modifications may be made without departing from the spirit and scope of the invention as set forth in the following claims.

What is claimed is:

1. An apparatus comprising:
a belt buckle comprising a digital display;
a battery operatively attached to the digital display;
a memory operatively attached to the digital display; and
an input, wherein the input facilitates the transfer of data of at least one of a still image and a video to the memory,
wherein the digital display of the belt buckle displays the at least one of the still image and video.

2. The apparatus of claim 1, further comprising a casing, wherein at least one of the digital display, the battery, and the memory are secured within.

3. The apparatus of claim 1, further comprising a speaker operatively connected with the digital display and memory.

4. A method of displaying an image from a belt buckle comprising:
providing the belt buckle comprising a digital display, a battery, a memory, and an input, wherein the belt buckle is attached to a belt;
placing the belt around a waist of a user and securing the belt to the waist using the belt buckle;
uploading data of at least one of a still image and a video to the memory through the input; and
displaying the at least one of the still image and the video on the digital display.
